(19) United States
(12) Patent Application Publication
(10) Pub. No.: US 2017/0200954 A1
(43) Pub. Date: Jul. 13, 2017

(54) FUEL CELLS CONSTRUCTED FROM SELF-SUPPORTING CATALYST LAYERS AND/OR SELF-SUPPORTING MICROPOROUS LAYERS

(71) Applicant: UTI LIMITED PARTNERSHIP, Calgary (CA)

(72) Inventors: Viola BIRSS, Calgary (CA); Xiaoan LI, Calgary (CA); Kunal KARAN, Calgary (CA); Dustin W. BANHAM, Calgary (CA)

(21) Appl. No.: 15/267,876

(22) Filed: Sep. 16, 2016

Related U.S. Application Data
(60) Provisional application No. 62/219,582, filed on Sep. 16, 2015.

(51) Int. Cl. H01M 4/86; H01M 4/92

(52) U.S. Cl. CPC H01M 4/861; H01M 4/926; H01M 2008/1095

(57) ABSTRACT

This invention discloses membrane electrode assemblies and fuel cells containing self-supporting catalyst layers and methods of generating electricity by operating such fuel cells. Self-supporting catalyst layers are used as the anode or cathode or both catalyst layers in fuel cells, most particularly as catalyst layers in polymer electrolyte membrane (PEM) fuel cells. Membrane electrode assembly configurations comprising self-supporting catalyst layers in which adjacent gas diffusion layers are absent. The invention also involves membrane electrode assemblies and fuel cells containing self-supporting microporous layers and fuel cells containing such membrane electrode assemblies and methods of generating electricity by operating such fuel cells.

### CROSS-REFERENCE TO RELATED APPLICATIONS

This application claims the benefit of U.S. Provisional Application No. 62/219,582, filed Sep. 16, 2015, which is hereby incorporated by reference in its entirety.

### BACKGROUND

Fuel cells have been extensively studied and developed in the past decades as they can cleanly and efficiently convert the chemical energy of fuels and oxidants to electricity. The main challenges to the wide commercialization of fuel cells are to decrease the manufacturing cost of fuel cells, to enhance their performance, and to prolong their life-time. The catalyst layers in polymer electrolyte membrane (PEM) fuel cells play a significant role in achieving these targets. Generally, a catalyst layer, composed of Pt nanoparticles loaded carbon powders and mixed with an ionomeric polymer and/or other components, such as polytetrafluoroethylene (PTFE) beads, is used. The present disclosure relates at least in part to PEM fuel cells in which the catalyst layers are self-supporting. In addition, the disclosure relates at least in part to the use of self-supporting microporous layers (films or scaffolds) as components in PEM fuel cells.

Carbonaceous materials with nanoscopic structures have been studied extensively and used widely in PEM fuel cells because of their low specific gravity, good electrical conductivity, high surface area, ability to be readily surface-modified, as well as the feasibility of large-scale production. Examples of these materials are carbon black, carbon nanotubes, carbon nanofibers, ordered mesoporous carbons, colloid imprinted carbon (CIC) [1, 2], and so on. However, most of these carbon materials are available only in powder form, which limits their applications. Variation in the orientation or alignment of the individual nanoporous carbon particles may affect mass transport through the nanopores and also make product properties irreproducible. In addition, use of carbon powders has associated health concerns, since particulates are known to be an increasing problem.

In some cases, carbon powders can be obtained already bound together with a polymer. For example, Pt-loaded nanoporous carbon can be bound with a polymer to serve as the catalyst layer in polymer electrolyte membrane fuel cells (PEMFCs), while carbon powders can be bound with a polymer to function as the microporous layer (MPL) of PEMFCs. However, these polymeric binders may negatively affect the conductivity or mass transfer through the carbon powders or may contaminate them, thus lowering their performance. The polymeric phase may also narrow the pathways for electrolyte ions and other species (e.g., reactant gases), which is expected to decrease the maximum current of the fuel cells.

In the past decade, a number of techniques have been developed to fabricate nanoporous carbonaceous materials in bulk form, e.g., carbon gels or monoliths, carbon films [3-6], carbon tapes [7], carbon cloth, etc. Of these, nanoporous carbon films (NCFs) are very promising for various applications, including applications as electrodes, adsorbents, catalysts, separation materials, and sensors. NCFs can be prepared via hard-template or soft-template methods, filtration, pyrolysis of polymer precursors, chemical or physical vapor deposition, and other chemical and physical methods [6, 8-14], These techniques can provide NCFs with excellent properties, but they also face one or more of the following problems: high cost of raw materials, complicated/tedious or time-consuming preparation process, low mechanical strength, low electrical conductivity, low porosity, non-continuous nano-pores, uncontrolled orientation of the pores, and challenges with mass production.

International patent application publication WO 2015/135069, relates to porous carbon-based films, including nanoporous carbon-based films, porous carbon films, nanoporous carbon films (NCFs), and methods for synthesis thereof. This application is incorporated by reference herein in its entirety for its description of such materials and methods for making such materials. Materials described therein include nanoporous carbon-based films comprising an open network of interconnected pores, and more specifically, materials in which the network comprises pores having a diameter from 2 nm to 100 nm and/or further comprises pores having a diameter smaller than 2 nm and/or larger than 100 nm. Materials described therein also include porous carbon-based films comprising open network of interconnected pore that have a diameter larger than 100 nm. The porous/nanoporous films may be self-supporting. The porous/nanoporous films may be supported by carbon fibers, a glass grid or glass fibers, or other materials.

The present invention relates to the use of such porous carbon based films, particularly self-supporting porous carbon based films, in fuel cells, specifically in fuel cell catalyst layers and/or microporous layers. The designs and/or methods of this invention are also applicable to porous films/scaffolds constructed of other types of carbon or of conducting materials other than carbon, but having similar properties.

### SUMMARY

This disclosure relates to fuel cells containing self-supporting catalyst layers and/or self-supporting microporous layers. In a first aspect, the disclosure relates to the use of such self-supporting catalyst layers as the anode or cathode or both catalyst layers in fuel cells, most particularly as catalyst layers in polymer electrolyte membrane (PEM) fuel cells.

In a second aspect, the disclosure relates to a new design for a PEM fuel cell in which one or both of the conventional gas diffusion layers (GDL's) of the fuel cell are not present. In these new configurations, a self-supporting catalyst layer replaces the conventional fuel cell catalyst layer of the anode, cathode or both and replaces the anode GDL, the cathode GDL layer or both.

In a third aspect, the disclosure relates to fuel cells using a self-supporting porous film or scaffold as the microporous layer, placed between a catalyst layer and the adjacent GD or the adjacent flow plate or bipolar plate.

In more detail, the first aspect of the disclosure includes membrane electrode assemblies (MEA) and fuel cells comprising self-supporting catalyst layers. In embodiments, MEAs of this aspect of the disclosure comprise a central electrolyte membrane, a cathode and an anode catalyst layer and an anode and a cathode GDL. MEAs optionally further include microporous layers between each catalyst layer and its adjacent GDL layer. In this aspect, one or both of the catalyst layers are self-supporting catalyst layers as described and exemplified herein. More specifically, one or both of the catalyst layers of the MEA are self-supporting carbon films loaded with catalyst. In specific embodiments, the electrolyte membrane of the MEA is a polymer electrolyte membrane. The disclosure also relates to fuel cells containing such MEAs and to methods of use of such fuel cells to generate electricity. In such fuel cells, the MEA is positioned between polar flow plates or bipolar plates which are normally electrically connected to each other by an external circuit. The fuel cell includes conduits for access of gas (fuel and oxidant, respectively) to the anode and cathode of the cell and exit of reaction products (e.g., water).

In more detail, the second aspect of the disclosure includes an MEA comprising a central electrolyte membrane and an anode, a cathode or both comprising a self-supporting catalyst layer and wherein the anode or cathode that comprises the self-supporting catalyst layer does not have a GDL. In a specific embodiment, the MEA includes a central electrolyte membrane and an anode and cathode both of which are self-supporting catalyst layers. The disclosure also relates to fuel cells containing such MEA wherein the self-supporting anode or cathode is in direct contact with flow channels of the polar flow plates without the presence of a GDL. The disclosure also relates to fuel cells containing such MEAs and to methods of use of such fuel cells to generate electricity. The use of this MEA configuration is believed to promote enforced gas flow through the catalyst layers.

In more detail, the third aspect of this disclosure includes an MEA and fuel cells comprising self-supporting microporous layers. In embodiments, MEAs of this aspect of the disclosure comprise a central electrolyte membrane, a cathode and an anode catalyst layer, self-supporting microporous layers, and GDLs. In some embodiments, the self-supporting microporous layer is placed between each catalyst layer and its adjacent GDL layer. In other embodiments, a self-supporting microprous layer is in direct contact with flow channels of the polar flow plates without the presence of a GDL. In further embodiments, the cathode catalyst layer, the anode catalyst layer or both are also a self supporting catalyst layer.

In embodiments of all of the aspects of the disclosure, the self-supporting catalyst layers are self-supporting porous or nanoporous carbon scaffolds (also called porous or nanoporous carbon films as referred to above) as described herein loaded with an appropriate catalyst, and the self-supporting microporous layer is a self-supporting porous or nanoporous carbon scaffold, as described herein. Useful self-supporting porous carbon scaffolds or nanoporous carbon scaffolds (NCS) include those having pores from 2-100 nm in diameter, with a thickness of 0.1-1000 μm. More specifically, porous carbon scaffolds or NCS include those scaffolds having pores from 10 to 100 nm in diameter and those having pores of 30 nm to 100 nm.

In embodiments, porous carbon scaffolds or NCS with pore sizes 2 to 100 nm, 10 to 100 nm in diameter or 30 nm to 100 nm are useful for self-supporting catalyst layers. In embodiments, the porosity of the porous or nanoporous carbon scaffold used for a self-supporting catalyst layer is from 70% to 90% or from 75% to 85%. In embodiments, porous carbon scaffolds or NCS for self-supporting catalyst layers are loaded with catalyst such that the catalyst represents from 1 to 80 wt % of the catalyst-loaded porous carbon scaffolds or NCS. More specifically, porous carbon scaffolds or NCS are loaded with catalyst such that the catalyst represents from 5 to 50 wt % of the catalyst-loaded porous carbon scaffolds or NCS. A porous or nanoporous scaffold made of other materials than carbon, but with the essential properties thereof, is also applicable for this invention. The designs and methods disclosed in this invention are also suitable for a scaffold having pores smaller than 2 nm or larger than 100 nm.

In embodiments of both the first and the second aspects of the disclosure, the catalyst loaded on the NSC is a metal or metal oxide, where the metal is selected from one or more of Pt, Pd, Ir, Ni, Au, Ag, Cu, Co, Ru, Rh, Ti, Ta, Fe, and combinations thereof. More specifically, the catalyst comprises metallic nanoparticles, where the metal is selected from one or more of Pt, Pd, Ir, Ni, Au, Fe, Co, Ru, Rh, Ti, Ta, Fe and combinations thereof. More specifically, the metal oxide nanoparticles are nanoparticles selected from the group consisting of ruthenium oxide, iridium oxide, titanium oxide, tantalum oxide, cobalt oxide, iron oxide, copper oxide, silver oxide, tungsten oxide, manganese oxide, chromium oxide, vanadium oxide, yttrium oxide, osmium oxide, nickel oxide, molybdenum oxide and combinations thereof. In an embodiment, the catalyst can comprise a combination of metallic and metal oxide nanoparticles. In particular embodiments, the catalyst consists of metallic nanoparticles wherein the metal is selected from Pt, Pd, Ir, Ni, Au, Co, Ru, Rh, Ti, Ta, Fe and combinations thereof. In particular embodiments, the catalyst comprises Pt nanoparticles in combination with nanoparticles of one or more of Pd, Ir, Ni, Au, Co, Ru, and Rh, Ti, Ta, Fe, etc.

In particular embodiments, the catalyst comprises Pt nanoparticles in combination with nanoparticles of one or more of Pd, Ir, Ni, Au, Co, Ru, and Rh, Ti, Ta, Fe, etc., wherein the Pt nanoparticles represent 50 wt % or more of the catalyst. In particular embodiments, the catalyst consists of Pt nanoparticles. In particular embodiments, the catalyst comprises Pt nanoparticles in combination with nanoparticles of one or more of ruthenium oxide, iridium oxide, titanium oxide, tantalum oxide, cobalt oxide, nickel oxide, or iron oxide, silver oxide, tungsten oxide, manganese oxide, chromium oxide, vanadium oxide, yttrium oxide, osmium oxide, molybdenum oxide, etc. In particular embodiments, the catalyst comprises Pt nanoparticles in combination with nanoparticles of one or more of ruthenium oxide, iridium oxide, titanium oxide, tantalum oxide, cobalt oxide, or iron oxide, silver oxide, tungsten oxide, manganese oxide, chromium oxide, vanadium oxide, yttrium oxide, osmium oxide, molybdenum oxide, etc., wherein the Pt nanoparticles represent 50 wt % or more of the catalyst.

In particular embodiments, elements other than carbon are introduced (or doped) into the carbon scaffold, making the scaffold function as catalyst by itself. The elements include nitrogen, sulfur, phosphorous, boron, silicon, chlorine, fluorine, arsenic, selenium, bromine, etc.

In embodiments of this disclosure, one or more of polymer electrolytes (or ionomers) are present in the self-supporting catalyst layers. In particular embodiments, polymer electrolytes facilitate the transfer of ions through the catalyst layers. In particular embodiments, the polymer electrolyte are present in the catalyst layers following certain patterns.

In particular embodiments of this disclosure, other components are added in the self-supporting catalyst layers to improve the performance of fuel cells. In particular embodiments, fluorinated materials or compounds are added in the catalyst layers to improve the gas transport within the layers. In particular embodiments, hydrophilic materials or compounds are added in the catalyst layers to prevent the dry-out of the catalyst layers during the operation of fuel cells at a low relative humidity.

Useful self-supporting porous carbon scaffolds for microporous layers include those having pores from 0.01 μm to 10 μm in diameter, with a thickness of 1 μm to100 μm. In further embodiments, the pore size of the porous carbon scaffolds for self-supporting microporous layers is from 0.1 μm to 1 μm. In additional embodiments, the microporous layer can include pores of other sizes. As example, the microporous layer can include pores smaller than 0.1 μm or larger than 1 μm. The microporous layer may be formed of a NCS. In additional embodiments, the thickness of the porous carbon scaffolds for self-supporting microporous layers is from 5 μm to 50 μm. In embodiments, the porosity of the porous carbon scaffold used for a self-supporting microporous layer is from 70% to 90% or from 75% to 85%.

Typically, adjacent membranes and/or layers of a membrane electrode assembly are in contact with one another. As an example, the polymer electrolyte membrane is typically in contact with the catalyst layers. In additional examples, the catalyst layers are in contact with the microporous layer or the gas diffusion layer.

Other aspects and embodiments of the disclosure will be apparent in view of the drawings, detailed description and examples.

### BRIEF DESCRIPTION OF THE DRAWINGS

FIG. 1 is a schematic illustration of a conventional fuel cell containing a conventional MEA. A PEM fuel cell is illustrated. The MEA contains polymer electrolyte, an anode and cathode catalyst layer, MPLs, and GDLs.

FIGS. 2A and 2B illustrate a five-layer and a seven-layer MEA configuration, respectively.

FIGS. 3A and 3B are schematic drawings of exemplary fuel cell designs using self-supporting catalyst layers with (FIG. 3A, seven-layer design) and without (FIG. 3B, five-layer design) microporous layers. In the configuration of FIG. 3A the microporous layer is normally part of the GDL.

FIGS. 4A and 4B are graphs of polarization curves (FIG. 4A) and power output curves (FIG. 4B) of a single fuel cell composed of self-supporting 30 wt. % Pt-loaded nanoporous carbon scaffold (NCS) as both the anode and cathode catalyst layers (size: ˜1 cm²), with polytetrafluoroethylene (PTFE) coated carbon fiber paper as the gas diffusion layer on one side of each catalyst layer, at various temperatures in 100% humidified H₂/Air.

FIGS. 5A, 5B and 5C illustrate the new fuel cell designs of this disclosure. FIG. 5A is a schematic drawing of an exemplary MEA of a fuel cell employing self-supporting catalyst layers (SSCLs) but having no GDLs. FIG. 5B is an alternative configuration in which an anode or cathode with only a SSCL is combined respectively with a cathode or anode having an SSCL, GDL and optional microporous layer. As illustrated in the fuel cell of FIG. 5C, having the MEA of FIG. 5A, the self-supporting catalyst layers are in direct contact with the polar flow plates of the fuel cell.

FIGS. 6A and 6B are graphs of polarization curves (FIG. 6A) and power output curves (FIG. 6B) of a single fuel cell composed of self-supporting 30 wt. % Pt-loaded nanoporous carbon scaffold (NCS) as both the anode and cathode catalyst layers (size: ˜1 cm²), at various temperatures in 100% humidified H₂/Air. The self-supporting catalyst layers are in direct contact with the polar plates of the fuel cell, as illustrated in FIG. 5C.

FIGS. 7A and 7B are graphs of polarization curves (FIG. 7A) and power output (FIG. 7B) of a single fuel cell, obtained by dividing the currents in FIGS. 6A and 6B, respectively, by the estimated functioning geometric area of the catalyst layer (0.2 cm²).

FIGS. 8A, 8B and 8C illustrate the new fuel cell designs of this disclosure. FIG. 8A is a schematic drawing of an exemplary MEA of a fuel cell employing self-supporting microporous layers (SSMPLs) but using conventional CLs. FIG. 8B is a schematic drawing of an exemplary MEA of a fuel cell employing self-supporting microporous layers (SSMPLs) and self-supporting CLs. FIG. 8C is a schematic drawing of an exemplary MEA of a fuel cell employing self-supporting microporous layers (SSMPLs) that are in direct contact with the polar plates.

FIGS. 9A and 9B are graphs of polarization curves (FIG. 9A) and power output curves (FIG. 9B) of a single fuel cell composed of self-supporting nanoporous carbon scaffold (NCS) as both the anode and cathode microporous layers (MPLs, size: ˜1 cm²) with commercial Pt/carbon black as catalyst for both electrodes, examined at various temperatures in 100% humidified H₂/Air.

### DETAILED DESCRIPTION OF THE INVENTION

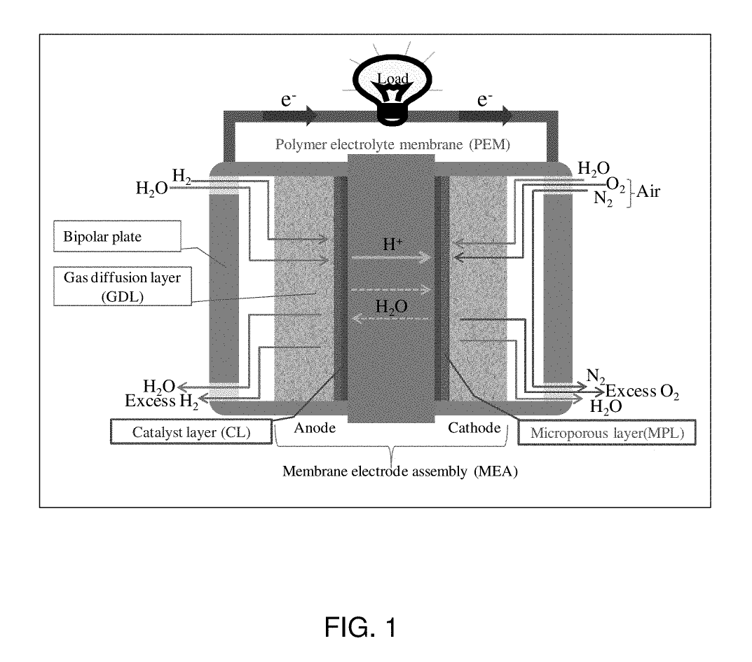

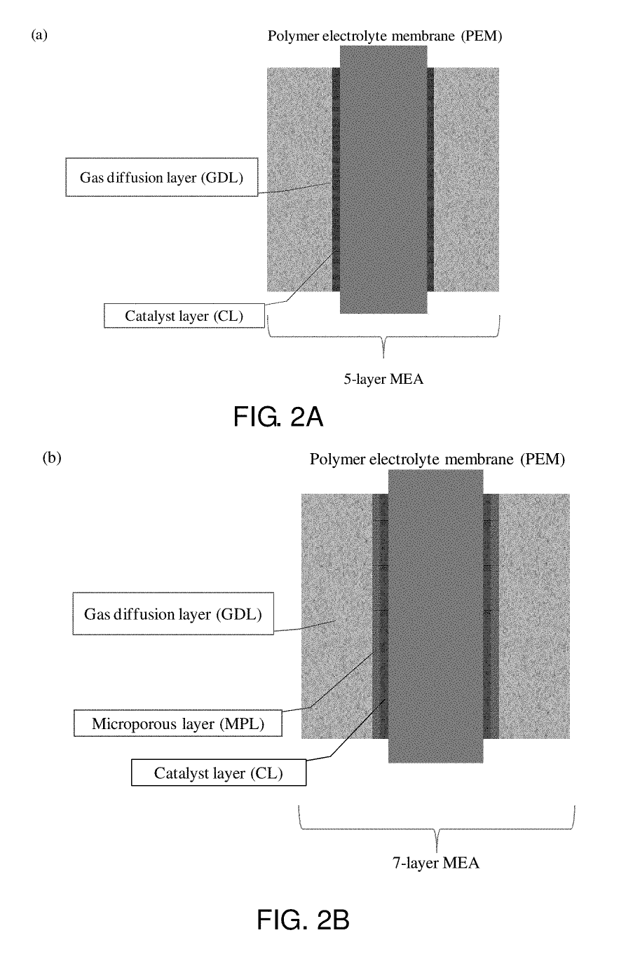

A polymer electrolyte membrane fuel cell (PEMFC) converts the chemical energy of fuels and an oxidant to electricity with electrical efficiencies up to 60% in practice. The fuels used in a PEMFC includes hydrogen, methanol, ethanol, formic acid, and so on, while the oxidant can be oxygen, hydrogen peroxide, peroxodisulfates, etc. Hydrogen (H₂) is used most commonly as the fuel for PEMFCs because of its high energy density of 33 kWh/kg and environmentally friendly regeneration (by the electrolysis of water, using renewable energy). As shown in FIG. 1, a PEMFC comprises two catalyst layers (CLs), separated by a polymer electrolyte membrane (PEM), with each CL attached to a microporous layer (MPL) which is connected to a gas diffusion layer (GDL) and then to a flow field plate or bipolar plate (bipolar plates are used when multiple fuel cells are stacked in series). Without including the bipolar plates, these components are collectively referred to as the membrane electrode assembly (MEA, FIGS. 2A and B), which is the core component of a PEMFC (FIG. 1).

At the anode catalyst layer (ACL), hydrogen (or other fuels, e.g., methanol) is oxidized following the electrochemical half reaction given in Reaction 1,

2H₂ [symbol] 4H⁺+4e⁻ E₀=0 V (1)

The generated protons are transported through the electrolyte membrane to the cathode catalyst layer (CCL), where they react with oxygen (FIG. 1) and the electrons are transported via the external circuit to form water, as shown in Reaction 2.

O₂+4H⁺+4e⁻ [symbol] 2H₂O E₀=1.23 V (2)

Hence, in this process, while H₂ and O₂ are consumed, electrical power and pure water are generated, with the overall reaction given in Reaction 3,

2H₂+O₂→2H₂O (3)

At both CLs, Pt nanoparticles are typically used to catalyze the redox reactions (Reactions 1 and 2). In order to decrease the cost and increase their utilization, the Pt nanoparticles are deposited on a carbon support, which has a relatively low cost as well as a high electronic conductivity, surface area, and porosity (pore size: 10-100 nm). Carbon black, such as Vulcan carbon XC-72R (VC), is currently the most widely used catalyst support [15-17].

A polymer electrolyte (ionomeric phase, FIG. 1), normally a poly(perfluorosulfonic acid) (PFSA), e.g., Nafion® polymer (Scheme 1), functions as an ion selective separator between the anode and the cathode, and also serves as a critical component of both the anode and cathode CLs, where its primary role is to facilitate H⁺ transport to/from the catalytic sites [18-23]. The polymer electrolytes useful in fuel cells herein typically contain anionic functional groups bound to a common backbone, such as sulfonic acid groups and carboxylic acid groups, imide groups, amide groups, or other acidic functional groups. Polymer electrolytes useful in the fuel cells herein can be highly fluorinated and perfluorinated. The polymer electrolytes useful in the fuel cells herein can be copolymers of tetrafluoroethylene and one or more fluorinated, acid-functional comonomers. In addition to Nafion® polymers, other commercially available PFSA materials are also available, such as Flemion® polymers and Aciplex® polymers. In addition, a number of new proton conducting polymer electrolytes are also being developed, e.g., sulfonated poly(ether ether ketone), sulfonated polyimide [24], and metal-organic framework materials [25], such as Na₃ (2,4,6-trihydroxy-1,3,5-benzenetrisulfonate) [26], but none of these have shown better properties than Nation® polymers. Each of references 18-26 are incorporated by reference herein in its entirety for descriptions of polymer electrolytes useful in the MEAs and fuel cells of this disclosure.

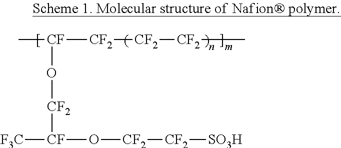

The polymer can be formed into a membrane by any methods known in the art. The polymer can, for example, be cast from a suspension/solution using any suitable casting method, including gap coating, spray coating, slit coating, or brush coating. The membrane can be formed from polymer in a melt process, such as extrusion. After forming, the membrane may be annealed as known in the art. In an embodiment, the membrane has a thickness of 0.1-500 microns, or of 1-50 microns, or of 10-30 microns, or of 20 to 30 microns.

Normally, non-woven carbon fiber paper or woven carbon fiber cloth is used as the GDL material (FIG. 1) to support and protect the catalyst layer coated membrane and to collect the current generated from the electrochemical reactions (Reactions 1 and 2) [27-28, 35]. These carbon fiber based materials typically have micrometer size pores (pore size: ˜10 μm), which facilitate the mass transport of humidified gases (FIG. 1), and provide good conductivity for current collection. Each of references 27, 28 and 35 are incorporated by reference herein in its entirety for descriptions of GDL materials and designs useful in the MEAs and fuel cells of this disclosure. GDL materials can include non-woven carbon paper with carbon nanotubes (CNT) on the surface (ElectroChem, Inc.)

A microporous layer (MPL), normally composed of carbon black and Teflon® beads (or Nation® polymer, used as the binder), is often placed between the carbon fiber paper (GDL) and the catalyst layer in order to improve the mass transport and current collection between these two layers (FIG. 2B). The MPL (pore size: 0.1-1 μm) is considered to be an important component of the GDL, and thus the carbon fiber paper/cloth is sometimes called a macroporous layer [29]. Exemplary microporous layers useful in fuel cells are described in reference 37. Each of references 29 and 37 are incorporated by reference herein in its entirety for descriptions of microporous layers and designs useful in the MEAs and fuel cells of this disclosure. The porosity of conventional MPLs can be about 50% or approximately 40%-60%,

An MEA without the presence of the MPL is normally called a 5-layer MEA (FIG. 2A), while that containing MPLs is a 7-layer MEA (FIG. 2B).

The bipolar plates (FIG. 1) are typically composed of polymeric graphite or metal, e.g., stainless steel, containing flow channels to provide the desired flow field of hydrogen and air at the anode and cathode, respectively [30,31]. The bipolar plate also functions as a current collector and mechanical support for the MEA. The sealing material is also a key component of a PEMFC, as it is important for the prevention of reactant gas leakage and is also important for performance stability and enhanced lifetime of PEMFCs [32, 33]. Exemplary bipolar plates useful for fuel cells include those described in U.S. Pat. Nos. 5,798,188 and 6,503,653 and published U.S. patent application 2010/0167105. Reference 37 provides a review of metallic bipolar plates for fuel cells. Each of these patent documents and references 30-33 and 37 is incorporated by reference herein in its entirety for descriptions of bipolar plates for fuel cells as well as sealing materials and methods for use of such plates.

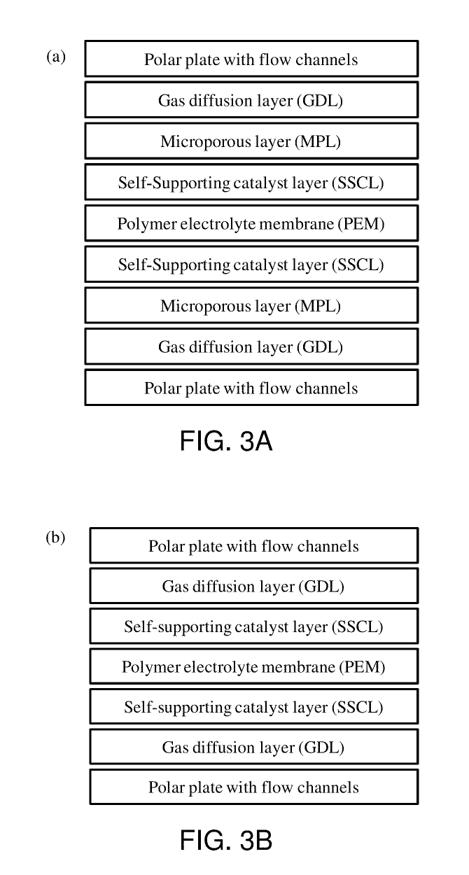

The MEA and fuel cell configuration of the present disclosure for PEM fuel cells include those in which the catalyst layers are self-supporting, with schematic configurations shown in FIGS. 3A and 3B (FIG. 3A with microporous layers and FIG. 3B without microporous layers). The use of self-supporting catalyst layers overcomes many of the problems associated with the deposition of powders, including reproducibility, variability between workers, safety, utilization of noble catalysts, and dislocation/disintegration of particles.

Referring back to FIG. 1, which shows a conventional single fuel cell assembly, reactant gases (or liquids) flow first through the GDL of the PEMFC, crossing from one channel to the adjacent ones, and diffusing through a microporous layer (MPL, if present) and then into the catalyst layer to reach the active sites. To the inventors' knowledge, there have been no efforts made to control the gas or liquid flow within the catalyst layers (CLs) of PEMFCs.

In embodiments, enforced flow within the CLs can significantly improve the mass transport of reactants and products through these layers and thus enhance PEMFC performance. This, in turn, minimizes the local drop in concentration of H₂, O₂, or methanol (for DMFC, or other reactants for various types of fuel cells) and accelerate the removal of water or other products, thus increasing the maximum current produced by PEMFCs. In current PEMFC designs, ink-based CLs cannot provide effective flow pathways for the gas or liquid reactants and products, especially at high humidity or under flooded conditions when the cathode CL is swollen by water. Additionally, the Nation® polymer-bound catalyst-loaded carbon particles can move, which is not desirable, when high pressure is applied to force gases to flow through the CL.

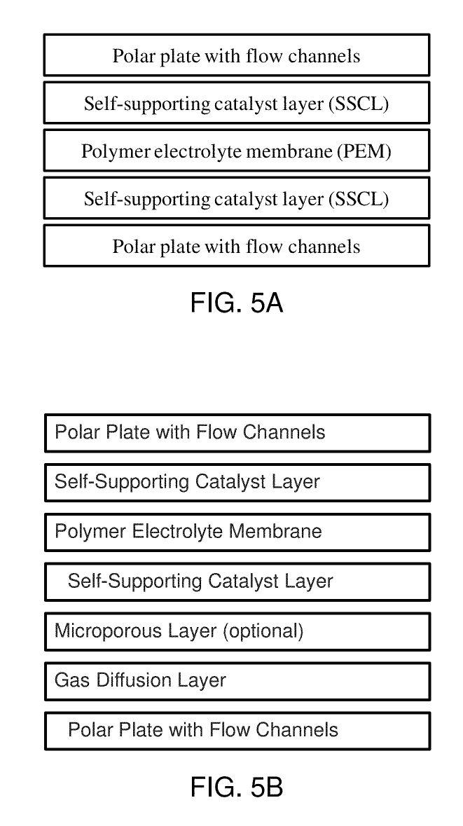

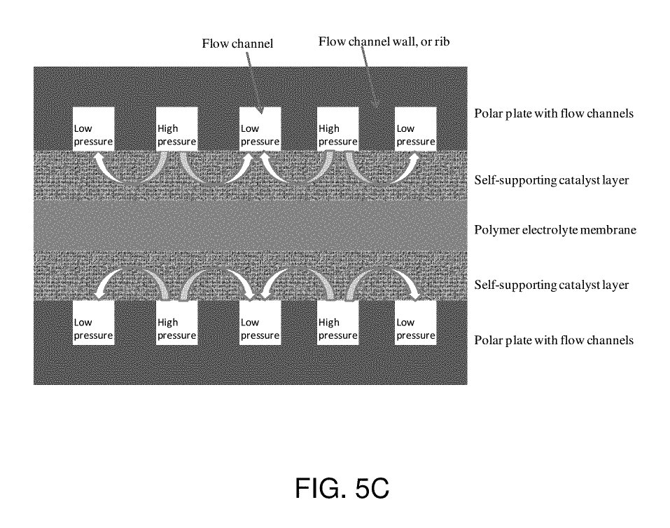

This disclosure describes a novel design, which involves enforced flow through the CLs by using two self-supporting catalyst layers (SSCLs), one on each side of the separator, as shown in FIG. 5A. Here, an SSCL preferably has a continuous and conductive porous structure, with the catalyst well distributed within the structure. It optionally has interconnected macropores (0.1-1 μm, or even larger) as well as some micropores (width <2 nm) and nanopores (2-100 nm), providing an opportunity to direct reactant flow through them.

FIG. 5C schematically shows the structure of an exemplary fuel cell constructed with an SSCL (the MEA of FIG. 5A) that allows enforced gaseous or liquid reactants/products flow through them. This design no longer requires a GDL, thus simplifying the design and manufacturing of PEM fuel cells. Ideally, the flow channels in the polar plates (FIG. 5C) are constructed to minimize the pressure drop within each channel, ensuring that the reactant reaches all regions of the CL, while also enhancing current collection (decreasing the IR drop). The channel structure can be further optimized to reach the best cell performance. The flow channels may be constructed using a range of geometrical patterns, such as serpentine, parallel, etc. Furthermore, the internal surfaces of the carbon channels can be modified to control their surface wettability in order to optimize the cell performance.

In an embodiment, one side of the PEM contains an SSCL, while the other side contains a conventional catalyst layer (or a self-supporting catalyst layer, SSCL), an optional MPL, and GDL layers, used in current PEMFC designs. In a specific embodiment, shown in FIG. 5B, one of the cathode or anode contains an SSCL with no GDL (or MPL), while the adjacent anode or cathode, respectively, contains an SSCL with a GDL and optional MPL. In an embodiment, both sides of the PEM fuel cell contain an SSCL, as in FIG. 5A.

In order to decrease the IR drop within an electrode of a PEMFC, especially the contact resistance between the catalyst layer and the bipolar plate, it is desirable to integrate the fuel cell electrode components. In this case, the SSCLs are attached directly to the flow channels of the polar plate, different from the individual components that are physically compressed together in conventional PEMFC designs. The SSCLs may be attached onto the flow channels, prior to surface modification and catalyst loading. This significantly simplifies the construction of a PEMFC while also decreasing the electrical resistance of the electrodes. The SSCLs are believed to be be able to survive the stress/pressure applied by the flow channels or gas pressure gradients between channels and through each channel, which requires them to have sufficient mechanically strength.

Exemplary SSCLs are made from porous or nanoporous carbon films (as described in WO 2015/135069). Additionally, carbon foams, nickel foams, porous metal oxides, conductive material coated porous nonconductive materials, or any other conductive porous material can be used. In embodiments an open network of interconnected pores in a porous film is “open” to flow of reactants through the film. The walls of the film are formed by the “framework” of the film, which may be carbon-based or of the materials described above. In embodiments, the catalysts (nanoparticles, thin films, etc) are loaded/coated on the porous structure/scaffold to carry out the electrochemical reactions within the fuel cells. In further embodiments, the catalysts are in/on the surface of SSCLs, e.g., bounded nitrogen, boron, phosphorus, sulfur, etc., with/without the coordination of metal atoms, such as iron, cobalt, nickel, copper, and so on. The SSCLs can also be composed of the catalyst itself, but having a porous structure. In some embodiments, the SSCLs have a thickness of 0.1 μm to 1 mm, optionally with a controlled pore size distribution in different directions.

The channels (or polar plates) of the fuel cell may be made of carbon, nickel, titanium, or other conductive materials or composites. The channels preferably have a width of 1-5000 μm and a depth of 1-5000 μm, with their length depending on the size of the fuel cells, potentially ranging from 1 mm to 100 cm. The channel wall (rib) width is preferably from 1 μm to 5 mm.

As the SSCLs provide (at least partially) the mechanical strength of the cell, the thickness of the polymer electrolyte membrane (PEM) can be varied from submicron to hundreds of microns. PEM may also be replaced by other conductive materials, such as proton conducting metal oxides. However, these materials should sufficiently separate the gaseous/liquid reactants of the cathode and anode.

More generally, the self-supporting catalyst layer contains a porous material with internally interconnected nanopores (size: 2-100 nm) and macropores (diameter >100 nm), facilitating the transport of reactants and products. The shape of the pores can be spherical, cylindrical, rectangular, or other geometric shapes. The pore walls are electrically conductive, allowing electricity to pass easily through the catalyst layer in any direction. The pore wall can be made of carbon, conductive polymers, metals, metal oxides, or a mixture of conductive and non-conductive materials. The geometrical area of the catalyst layers may vary from smaller than 1 mm² to larger than 100 cm², and the thickness of the layers can be less than 1 μm to more than 1 mm. The catalytic materials can be metallic, metal oxide, polymeric, or inorganic nanoparticles, surfaces dopants (e.g., nitrogen, sulfur, boron, phosphorous, etc.), or nanofilms (conformal or porous thin coatings on the porous structure). In some embodiments, the self-supporting catalyst layer is composed of the catalyst material itself.

In embodiments, the self-supporting catalyst layer is formed from self-supporting or supported porous carbon films, including nanoporous carbon films, such as those described in WO 2015/135069.

In an embodiment, the catalyst of the self-supporting can be platinum or mixtures of platinum with one or more other metals. In specific embodiments, the catalyst comprises 50 to 100% by weight Pt. In an embodiment, the catalyst is selected from the group consisting of metallic nanoparticles and metal oxide nanoparticles. More specifically, the metallic nanoparticles are selected from the group consisting of Pt, Pd, Ir, Ni, Au, Co, Ru, Rh, Ti, Ta, Fe and combinations thereof. More specifically, the metallic nanoparticles are selected from Pt in combination with one or more of Pd, Ir, Ni, Au, Co, Ru, Rh, Ti, Ta and Fe. In specific embodiments, Pt is 10 wt %, 20 wt %, 30 wt %, 40 wt %, 50 wt %, 60 wt %, 70 wt %, 80 wt %, or 90 wt % or more of the catalyst.

In a given self-supporting catalyst layer, the catalyst content of the layer can range from 1 wt % to 90 wt %. More specifically, the catalyst content of the layer can range from 10 wt % to 60 wt %. More specifically, the catalyst content of the layer can range from 20 wt % to 40 wt %. More specifically, the catalyst content of the layer can range from 27 wt % to 33 wt %. More specifically, the catalyst content of the layer is about 30 wt %. In a subset of the forgoing embodiments, the catalyst is Pt or the catalyst comprising 50 wt % or more Pt in combination with one or more of Pd, Ir, Ni, Au, Co, Ru, Rh, Ti, Ta, Fe, etc.

In particular embodiments, elements other than carbon are introduced (or doped) into the carbon scaffold, which are selected from nitrogen, sulfur, phosphorous, boron, silicon, chlorine, fluorine, arsenic, selenium, bromine, etc. The content of these elements other than carbon of the layer can range from 0.1 wt % to 20 wt %. More specifically, the content of these elements other than carbon of the layer can range from 1 wt % to 10 wt %.

In a given self-supporting catalyst layer, the ionomer content of the layer can range from 0 to 80 wt %. More specifically, the ionomer content of the layer can range from 20 wt % to 60 wt %. More specifically, the ionomer content of the layer can range from 30 wt % to 50 wt %. In some embodiments, a gradient in ionomer content is present within the film. In an example, a concentration gradient is present through the thickness of the film. In embodiments, the ionomer content of the self-supporting catalyst layer decreases from the electrolyte membrane side to the MPL (when the MEA is viewed in cross-section). In additional embodiments, the ionomer content in the CL decreases from the gas inlet area to the outlet area (in the direction of the flow field of the PEMFC).

In a given self-supporting catalyst layer, the additives, other than the components mentioned above, can range from 0 to 50 wt %. More specifically, the content of the additives in the layer can range from 10 wt % to 40 wt %. More specifically, the ionomer content of the layer can range from 20 wt % to 30 wt %.

As used herein, with respect to the pore structure of a film, “nanoporous” refers to pores having diameters ranging from <2 nm up to about 100 nm. In an embodiment, a nanoporous film comprises nanopores, but may also comprise some larger pores. In another embodiment, the nanoporous film has a narrow pore size distribution. In different embodiments, the synthesis methods, modification, and applications of the nanoporous carbon films, as described in this patent, are also able to be used for carbon films with pores smaller than 2 nm or larger than 100 nm.

Porous or nanoporous carbon-based films can be supported by other materials in order to achieve higher mechanical strength or electrical conductivity. In an embodiment, carbon fiber paper (CFP) is used as a support because of its similar chemical composition, good compatibility, similar thermal extension coefficients, and high-temperature stability (under an inert atmosphere). In an embodiment, the carbonized porous or nanoporous carbon-based film (before or after removing silica) is attached to CFP with PVA (or other binders), followed by pyrolysis of the PVA (or the binder). Other materials (e.g., MP) may be added to the PVA solution (even replacing it) for the purpose of attaching the porous or nanoporous carbon-based films onto a support.

The porous or nanoporous carbon-based films can be loaded with various catalysts, such as Pt nanoparticles and enzymes (for use in biofuel. cells). The catalysts can be loaded directly onto the self-supporting porous or nanoporous carbon-based film, or on the supported films. The catalysts can be loaded onto the surfaces of the porous or nanoporous carbon-based film using methods known to the art, such as wet impregnation, sputter-coating, precipitation, electrodeposition, thermal decomposition, chemical/physical vapor deposition, and so on. In an embodiment, the catalysts are distributed within the porous or nanoporous carbon-based films in a graded manner, either through the porous or nanoporous carbon-based film or along its length, or in other patterns. In an embodiment, the catalysts are distributed only a part of the porous or nanoporous carbon-based films, optionally in a graded manner, while the rest of the films have no catalyst supported.

In embodiments, the porous or nanoporous carbon-based films that have been described above, with/without supports, are used as self-supporting microporous layers in an MEA and fuel cells. In an embodiment, a porous carbon-based films with a support can be used as both self-supporting microporous layer and GDL. In an embodiment, the porous carbon-based film is placed between each catalyst layer and its adjacent GDL layer. In an embodiment, a porous carbon-based film, functioning as a MPL, is in direct contact with flow channels of the polar flow plates without the presence of a GDL. In further embodiments, other electrically conductive porous films such as carbon foams, nickel foams or conductive materials coated with porous nonconductive materials are suitable for microporous layers.

In this disclosure, a self-supporting nanoporous carbon film (NCF) is also called nanoporous carbon scaffold (NCS), and a porous structure is occasionally referred to as a scaffold.

A ‘membrane electrode assembly’ in this invention refers to all of the configurations in which an electrolyte membrane is coated on each side by a catalyst layer, and/or a microporous layer (MPL), and/or a gas diffusion layer (GDL).

All references cited herein are hereby incorporated by reference to the extent not inconsistent with the disclosure herewith. WO 2015/135069 is hereby incorporated by reference in its entirety, including incorporation for disclosure of methods for making, characterization and properties of porous carbon-based films and scaffolds, including nanoporous carbon-based films and scaffolds.

Although the description herein contains many specifics, these should not be construed as limiting the scope of the invention but as merely providing illustrations of some of the presently preferred embodiments of the invention. Thus, the scope of the invention should be determined by the appended claims and their equivalents, rather than by the examples given.

When a Markush group or other grouping is used herein, all individual members of the group and all combinations and sub-combinations possible of the group are intended to be individually included in the disclosure.

Every formulation or combination of components described or exemplified can be used to practice the invention, unless otherwise stated. Specific names of compounds are Intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials, and synthetic methods, other than those specifically exemplified can be employed in the practice of the invention without resort to undue experimentation. All art-known functional equivalents, of any such methods, device elements, starting materials, and synthetic methods, are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,”, “composed of”, or “characterized by,” and is inclusive or open-ended and does not exclude additional, unrecited elements or method steps. As used herein, “consisting of” does not exclude any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general, the terms and phrases used herein have their art-recognized meaning, which can be found by reference to standard texts, journal references and contexts known to those skilled in the art. The preceding definitions are provided to clarify their specific use in the context of the invention.

The invention may be further understood by the following non-limiting examples.

### THE EXAMPLES

### Example 1: Preparation of Self-Supporting Nanoporous Carbon Films (NCFs)

Additional details of these methods are provided in Appendix A. In the work described in this example, a scalable method was developed to prepare self-supporting nanoporous carbon films (NCFs), based on colloid imprinted carbons (CICs) and involving the following steps: 1) casting an aqueous precursor mixture that includes carbon precursor(s), surfactant(s), silica-based structure templates, binder(s), plasticizer(s), and additives, on a substrate, 2) drying the mixture to form a film, 3) heat-treating (carbonizing) the film, and then 4) removing the silica template. Tape-casting is the preferred method to prepare these films, as it is applicable for manufacturing at a large scale. The thickness of the films can be controlled (e.g. from 100 nm to 1 mm) by changing the concentration of the aqueous precursor mixture or adjusting the gap between the doctor blade and the substrate during tape-casting. The pore size of the films in this example was controlled by using silica nanoparticles with different diameters as the template, with the pores ranging from 7 nm to 100 nm. The films can be loaded with catalysts via a wet impregnation method (see Examples 2 and 3).

### Slurry Preparation

One procedure used to prepare nanoporous carbon films with a pore size of 85 nm was as follows. 0.100 g mesophase pitch (MP, AR Grade, Mitsubishi Chemicals, Japan) and 0.300 g n-butanol were mixed in a polypropylene (PP) bottle and then ball-milled (90 rpm, 2 hours) using alumina balls, each 4 mm in diameter. 3.50 g of 10 wt % polyvinyl alcohol (PVA, Alfa Aesar, 86-89% hydrolyzed, high molecular weight) in water was then added to the bottle and this mixture was then ball-milled for another 3 h to produce a homogeneous MP/PVA ink.

A colloidal silica suspension (Nexsil-125-40, with an average colloid size of 85 nm), containing 0.7 g of silica, was added to 1.4 g of 1,3-propanediol (PD) and water (mass ratio: 2:3) mixture to produce a silica suspension. The silica suspension was added to the MP/PVA ink and the mixture was ball-milled for 24 h to obtain the MP/PVA/PD/silica ink (or slurry). The ink was degassed under house vacuum for 15 min to remove any trapped bubbles before use.

Carbon Film Preparation

The slurry was cast on a glass substrate using a casting blade with a 0.025 inch (0.635 mm) gap between the doctor blade and the substrate. After drying overnight, a pristine composite MP/PVA/PD/silica film was obtained. The film was cut into small pieces, dried, and then placed between two carbon-coated alumina plates. This assembly was inserted into an alumina tubular furnace and carbonized at 900° C. for 2 h in a nitrogen atmosphere, heating at a ramp rate of 0.1-2° C./min. Prior to reaching 900° C., the temperature was held at 400° C. for 2 h. After cooling, the carbonized films were soaked in 3 M NaOH at 80° C. for 2 days to remove the silica template. Following this, the films were washed with deionized water a few times to a neutral state and then soaked in diluted HCl for one day to remove any Na⁺ ions still attached to the carbon surface. After washing with deionized water several times, the films were placed in an oven for drying in air at 80° C. overnight. The resulting self-supporting nanoporous films were stored in conductive containers, e.g., aluminum covered Petri dishes, to avoid electrostatic effects. These nanoporous carbon films were labelled as NCF-85 (or NCS-85), with “85” corresponding to the template silica particle size of 85 nm. The self-supporting NCF are also designated NCS (nanoporous carbon scaffold).

Note that, when a NCS with pore size of x nm is prepared using the method above, it involves the use of a colloidal silica suspension having an average colloid size of x nm, e.g., Ludox-HS-40, Ludox-AS-40, NanoSol-5050S, or NanoSol-5080S, in this case x=12, 22, 50, or 80, respectively.

More detail on the characterization and properties of nanoporous carbon films and scaffolds is provided in WO 2015/135069, hereby incorporated by reference.

The synthesized NCS-85 was further treated at 1500° C. under a nitrogen atmosphere for 2 h at a heating rate of 2.5° C. min⁻¹, and the heat-treated carbon was labelled as NCS-85-HT,

### Example 2: Preparation of Self-Supporting Catalyst Layers

Self-supporting nanoporous carbon scaffolds (NCS, also called nanoporous carbon films (NCF)), having pore diameters from 2-100 nm in diameter, a thickness of 0.1-1000 μm and an area of 0.01-10000 cm², were loaded with Pt using a wet impregnation procedure [34]. An example procedure follows:

A NCS with a pore size of ca. 85 nm, a thickness of ca. 40 μm, and an area of ca. 20 cm², was loaded with Pt by dissolving 0.0133 g of H₂PtCl₆.6H₂O in 0.1248 g acetone in a small vial. The chloroplatinic acid solution was added to 0.0180 g of the NCS. After evaporation of the acetone under room conditions, the composite was placed in a tubular furnace and heated to 300° C. under a H₂ atmosphere over a period of 2 h. The sample was maintained at this temperature for 2 h under N₂ and was then cooled to room temperature. The obtained sample was named Pt/NCS, with a Pt content of ˜30 wt. %. Using the methods provided, the catalyst content can be varied from about 1 wt % to about 50 wt % Pt or using other appropriate catalysts.

### Example 3: Attaching Catalyst-Loaded Nanoporous Carbon Scaffolds (Pt/NCS) to Nafion® Polymer Membrane

Two pieces of Pt-loaded NCS (Pt/NCS), each ca. 1 cm² in area, were obtained by cutting them from the larger Pt-loaded scaffold, and were then placed on two pieces of polytetrafluoroethylene (PTFE) coated carbon fiber paper (CFP, size: 2.2×2.2 cm²) (as the gas diffusion layer (GDL)), separately. About 0.2 mL of 1 wt. % Nafion® polymer/ethanol solution was deposited on each of the catalyst scaffolds (Pt/NCS) and left at ambient conditions to allow the evaporation of ethanol. Immediately after the evaporation of ethanol, the Pt/NCS/CFP specimens were placed onto each side of a freshly cleaned and dried Nation® membrane (N112) by pressing the assembly with a load of 2 kN at 80° C. for 1 min. A membrane electrode assembly (MEA) was thus obtained.

In an alternative method, the Nafion® polymer-coated Pt/NCS specimens are hot pressed onto a Nation® membrane.

### Example 4: Fuel Cell Tests with GDLs

The MEA (with GDLs), as prepared in Example 3, was placed between two graphite plates, having a serpentine-patterned flow field (size: 18×18 mm², rib width: 0.5 mm, and channel width: 1.5 mm) to contact the MEA, which were further sandwiched by two water jackets (for temperature control), forming a cell assembly. The cell was held under a pressure of 80-100 psi using a pneumatic air cylinder (Humphrey Automation). 100% humidified H₂ and air were allowed to flow through the anode and cathode sides of the cell at a rate of 30 and 25 sccm, respectively. The polarization curves of the cell were collected at various temperatures (22, 40, and 60° C.), using a fuel cell test system (Model 850C, Scribner Associates, Inc.).

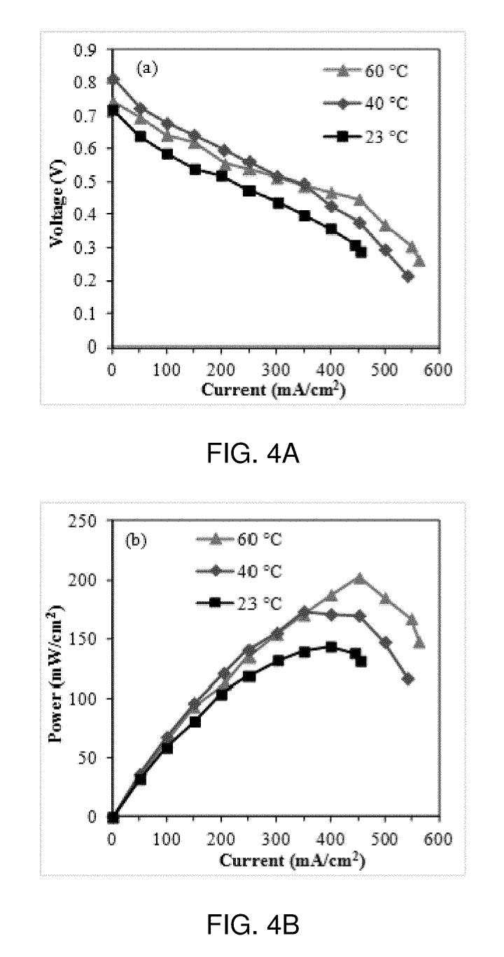

FIGS. 4A and 4B show the performance of the fuel cell using the 30% Pt-loaded nanoporous carbon scaffold (Pt/NCS, pore size=85 nm) as the catalyst layers. Each data point in the figures was obtained by averaging the voltage or power as the corresponding current was held for at least 5 min.

### Example 5: Fuel Cells without GDLs

Two pieces of Pt-loaded NCS (Pt/NCS), each ca. ˜1 cm² in area, were obtained by cutting them from the larger Pt-loaded scaffold, and were then placed on two pieces of polytetrafluoroethylene (PTFE) tape (size: 2.5×2.5 cm²), separately. About 0.2 mL of 1 wt. % Nafion/ethanol solution was deposited on each of the catalyst scaffolds (Pt/NCS) and left at ambient conditions to allow the evaporation of ethanol. Immediately after the evaporation of ethanol, the Pt/NCS specimens were transferred onto each side of a freshly cleaned and dried Nafione membrane (N112) by pressing the assembly with a load of 4.5 kg at room temperature for 2 h. A catalyst coated membrane (CCM) was thus obtained after the removal of the PTFE tapes.

### Example 6: Fuel Cell Test without GDLs

The CCM prepared in Example 5 was placed between two graphite plates having a serpentine-patterned flow field (size: 18×18 mm², rib width: 0.5 mm, and channel width: 1.5 mm) to contact the CCM, which were further sandwiched by two water jackets (for temperature control), forming a cell assembly. The cell was held under a pressure of 80-100 psi. 100% humidified H₂ and air were allowed to flow through the anode and cathode sides of the cell at a rate of 30 and 50 sccm, respectively. The polarization curves of the cell were collected at various temperatures (22, 30, 40, and 50° C.), using a fuel cell test system (Model 850C, Scribner Associates, Inc.).

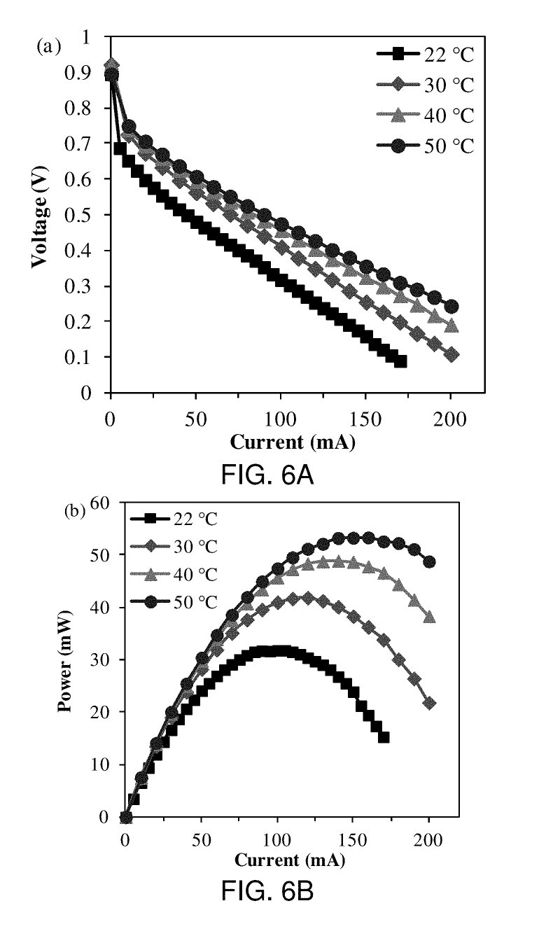

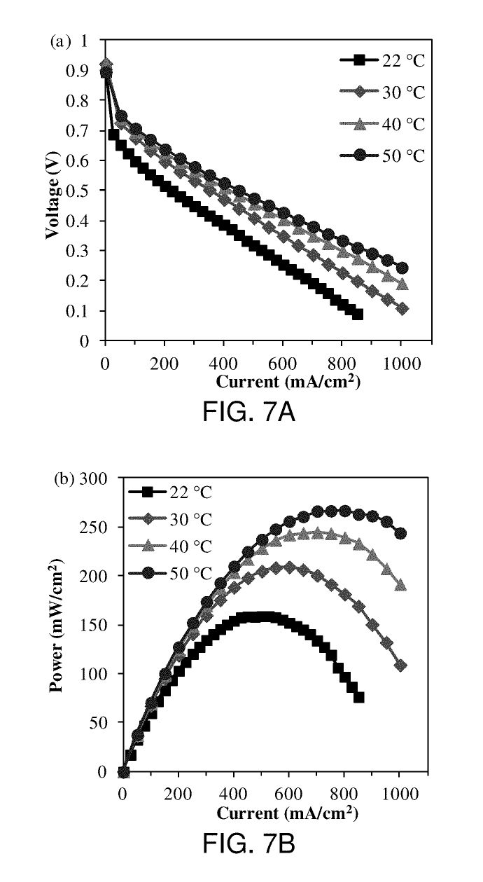

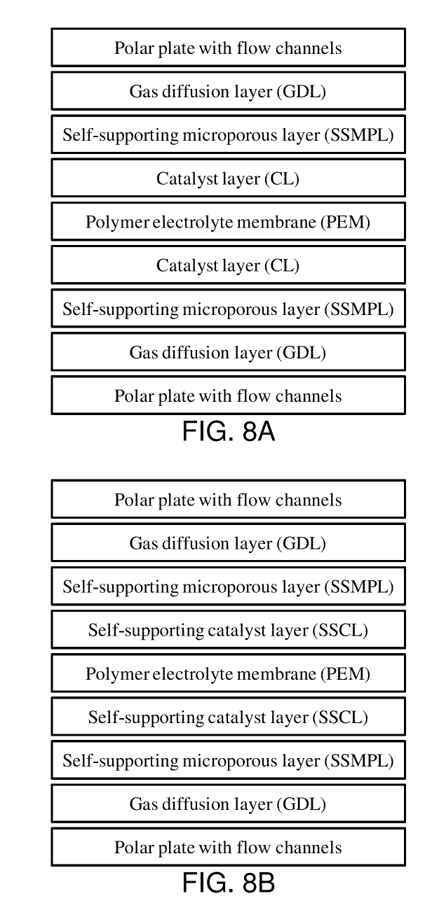

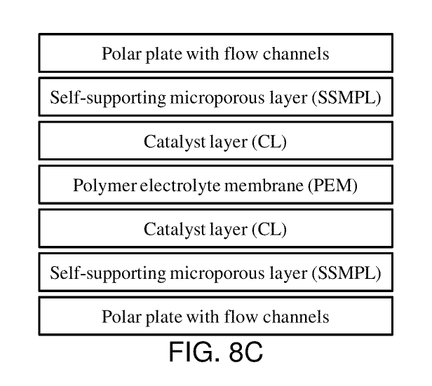

FIGS. 6A and 6B shows the non-optimized performance of the fuel cell using the 30% Pt-loaded nanoporous carbon scaffold (Pt/NCS, pore size=85 nm) as the catalyst layers. GDLs were not present in this cell. This novel design improves the gas diffusion and water removal processes in the catalyst layers, thus enhancing the performance of the fuel cells. In the present example, it is believed that the entire area (1 cm²) of the catalyst layers was not completely utilized, due to the wide channels and narrow ribs of the flow fields, which caused a significant resistance loss through the catalyst layers. The real area of functioning catalyst layer was estimated to be ca. 0.2 cm², and thus the fuel cell current was divided by this active area, as shown in FIGS. 7A and 7B. The performance of this cell without GDLs is considered to be quite remarkable, particularly considering that the self-supporting catalyst layers (SSCLs) were simply pressed onto the Nafion® polymer membrane.

### Example 7: MEA Having Nanoporous Carbon Scaffolds as Microporous Layers

The catalyst layers shown in this example were prepared by using a commercially available 20 wt % platinum loaded carbon black (Pt/CB) bound with Nafion. 0.0098 g of 20 wt % Pt/CB was placed in a vial, followed by the addition of 0.0980 g of water and 0.38 g of 1 wt % Nafion/ethanol solution. The mixture was sonicated for 1 hour to form an ink. A part of the ink was then painted on onto both sides of a freshly cleaned and dried Nation® membrane (N112), which was placed on heat plate (ca. 100° C.), forming a catalyst-coated membrane (CCM). The as-prepared CCM has an active area of 1×1 cm² and a Pt loading of 0.23 mg on each side of the membrane. Onto each side of the CCM, a piece of NCS-85-HT (size: 1×1 cm²) and a piece of polytetrafluoroethylene (PTFE) coated CFP (size: 2.2×2.2 cm²) were placed to cover the catalyst layer. The CFP/NCS-85-HT/CCM/NCS-85-HT/CFP assembly was pressed with a load of 2 kN at 120° C. for 2 min. A membrane electrode assembly (MEA) was thus obtained.

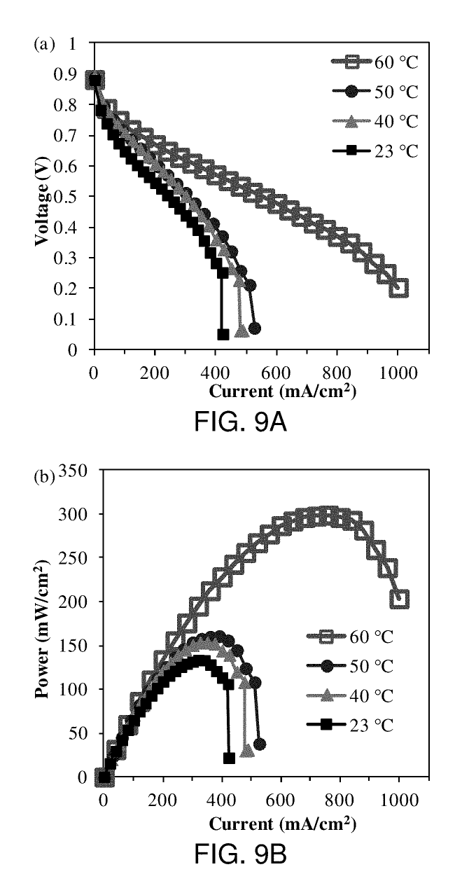

The as-prepared MEA (with heat-treated NCS-85 as MPLs) was placed between two graphite plates, having a serpentine-patterned flow field (size: 18×18 mm², rib width: 0.5 mm, and channel width: 1.5 mm) to contact the MEA, which were further sandwiched by two water jackets (for temperature control), forming a cell assembly. The cell was held under a pressure of ca. 100 psi using a pneumatic air cylinder (Humphrey Automation). 100% humidified H₂ and air were allowed to flow through the anode and cathode sides of the cell at a rate of 30 and 50 sccm, respectively. The polarization curves of the cell were collected at various temperatures (e.g., 23, 40, 50, and 60° C.), using a fuel cell test system (Model 850C, Scribner Associates, Inc.), and shown in FIGS. 9A and 9B.

### REFERENCES

1. Banham D, Feng F, Fürstenhaupt T, Pei K, Ye S, Birss V. Effect of Pt-loaded carbon support nanostructure on oxygen reduction catalysis. J Power Sources 2011; 196(13):5438-45.
2. Pei K, Banham D, Feng F, Fuerstenhaupt T, Ye S, Birss V. Oxygen reduction activity dependence on the mesoporous structure of imprinted carbon supports. Electrochem Commun 2010; 12(11):1666-9.
3. Kimijima K I, Hayashi A, Yagi I. Preparation of a self-standing mesoporous carbon membrane with perpendicularly-ordered pore structures. Chemical Communications 2008(44):5809-11.
4. Liang C D, Hong K L, Guiochon G A, Mays J W, Dai S. Synthesis of a large-scale highly ordered porous carbon film by self-assembly of block copolymers. Angewandte Chemie-International Edition 2004; 43(43):5785-9.
5. Labiano A, Dai M, Young W-S, Stein G E, Cavicchi K A, Epps T H, III, et al. Impact of Homopolymer Pore Expander on the Morphology of Mesoporous Carbon Films Using Organic-Organic Self-Assembly. Journal of Physical Chemistry C 2012; 116(10):6038-46.
6. Tanaka S, Katayama Y, Tate M P, Hillhouse H W, Miyake Y. Fabrication of continuous mesoporous carbon films with face-centered orthorhombic symmetry through a soft templating pathway. Journal of Materials Chemistry 2007; 17(34):3639-45.
7. Korkut S, Roy-Mayhew J D, Dabbs D M, Milius D L, Aksay I A. High Surface Area Tapes Produced with Functionalized Graphene. Acs Nano 2011; 5(6):5214-22.
8. Mahurin S M, Lee J S, Wang X, Dai S. Ammonia-activated mesoporous carbon membranes for gas separations. Journal of Membrane Science 2011; 368(1-2):41-7.
9. Song L, Feng D, Fredin N J, Yager K G, Jones R L, Wu Q, et al. Challenges in Fabrication of Mesoporous Carbon Films with Ordered Cylindrical Pores via Phenolic Oligomer Self-Assembly with Triblock Copolymers. Acs Nano 2009; 4(1):189-98.
10. Chmiola J, Largeot C, Taberna P-L, Simon P, Gogotsi Y. Monolithic Carbide-Derived Carbon Films for Micro-Supercapacitors. Science 2010; 328(5977):480-3.
11. Moriguchi I, Nakahara F, Furukawa H, Yamada H, Kudo T. Colloidal crystal-templated porous carbon as a high performance electrical double-layer capacitor material. Electrochemical and Solid State Letters 2004; 7(8):A221-A3.
12. Ye X, Qi L. Two-dimensionally patterned nanostructures based on monolayer colloidal crystals: Controllable fabrication, assembly, and applications. Nano Today 2011; 6(6):608-31.
13. Wang O, Moriyama H. Carbon Nanotube-Based Thin Films: Synthesis and Properties: InTech; 2011.
14. Siegal M P, Overmyer D L, Kottenstette R J, Tallant D R, Yelton W G. Nanoporous-carbon films for microsensor preconcentrators. Applied Physics Letters 2002; 80(21):3940-2.
15. Liu Z, Gan L M, Hong L, Chen W, Lee J Y. Carbon-supported Pt nanoparticles as catalysts for proton exchange membrane fuel cells. J Power Sources 2005; 139(1-2):73-8.
16. Moreira J, del Angel P, Ocampo A L, Sebastian P J, Montoya J A, Castellanos R H. Synthesis, characterization and application of a Pd/Vulcan and Pd/C catalyst in a PEM fuel cell. Int J Hydrogen Energy 2004; 29(9):915-20.
17. Litster S, McLean G. PEM fuel cell electrodes. J Power Sources 2004; 130(1-2):61-76.
18. Hayashi A, Notsu H, Kimijima Ki, Miyamoto J, Yagi I. Preparation of Pt/mesoporous carbon (MC) electrode catalyst and its reactivity toward oxygen reduction. Electrochim Acta 2008; 53(21):6117-25.
19. Ticianelli E A, Derouin C R, Redondo A, Srinivasan S. Methods to advance technology of proton-exchange membrane fuel-cells. J Electrochem Soc 1988; 135(9):2209-14.
20. Do J-S, Liou B-C. A mixture design approach to optimizing the cathodic compositions of proton exchange membrane fuel cell. J Power Sources 2011; 196(4):1864-71.
21. Gode P, Jaouen F, Lindbergh G, Lundblad A, Sundholm G. Influence of the composition on the structure and electrochemical characteristics of the PEFC cathode. Electrochim Acta 2003; 48(28):4175-87.
22. Passalacqua E, Lufrano F, Squadrito G, Patti A, Giorgi L. Nation content in the catalyst layer of polymer electrolyte fuel cells: effects on structure and performance. Electrochim Acta 2001; 46(6):799-805.
23. Wang Q P, Eikerling M, Song D T, Liu Z S. Structure and performance of different types of agglomerates in cathode catalyst layers of PEM fuel cells. J Electroanal Chem 2004; 573(1):61-9.
24. Borup R, Meyers J, Pivovar B, Kim Y S, Mukundan R, Garland N, et al. Scientific aspects of polymer electrolyte fuel cell durability and degradation. Chem Rev (Washington, D.C., US) 2007; 107(10):3904-51.
25. Ramaswamy P, Wong N E, Shimizu G K H. MOFs as proton conductors challenges and opportunities. Chem Soc Rev 2014; 43(16):5913-32.
26. Hurd J A, Vaidhyanathan R, Thangadurai V, Ratcliffe C I, Moudrakovski I L, Shimizu G K H. Anhydrous proton conduction at 150° C. in a crystalline metal-organic framework. Nat Chem 2009; 1(9):705-10.
27. Cindrella L, Kannan A M, Lin J F, Saminathan K, Ho Y, Lin C W, et al. Gas diffusion layer for proton exchange membrane fuel cells-A review. J Power Sources 2009; 194(1):146-60.
28. Benziger J, Nehlsen J, Blackwell D, Brennan T, Itescu J. Water flow in the gas diffusion layer of PEM fuel cells. J Membr Sci 2005; 261(1-2):98-106.
29. Dai W, Wang H, Yuan X-Z, Martin J J, Yang D, Qiao J, et al. A review on water balance in the membrane electrode assembly of proton exchange membrane fuel cells. Int J Hydrogen Energy 2009; 34(23):9461-78.
30. Middelman E, Kout W, Vogelaar B, Lenssen J, de Waal E. Bipolar plates for PEM fuel cells. J Power Sources 2003; 118(1-2):44-6.
31. Li X G, Sabir M. Review of bipolar plates in PEM fuel cells: Flow-field designs. Int J Hydrogen Energy 2005; 30(4):359-71.
32. Wu J, Yuan X Z, Martin J J, Wang H, Zhang J, Shen J, et al. A review of PEM fuel cell durability: Degradation mechanisms and mitigation strategies. J Power Sources 2008; 184(1):104-19.
33. de Bruijn F A, Dam V A T, Janssen G J M. Review: Durability and degradation Issues of PEM fuel cell components. Fuel Cells 2008; 8(1):3-22.
34. Banham D, Feng F, Fürstenhaupt T, Pei K, Ye S, Birss V. Effect of Pt-loaded carbon support nanostructure on oxygen reduction catalysis. J Power Sources 2011; 196(13):5438-45.
35. Park S., Lee J-W., Popov B. N., (April 2012) “A review of gas diffusion layer I PEM fuel cells: Materials and designs,” Int. J. Hydrogen Energy 37(7):5850-5865.
36. Botelho S. J., Bazylak A. (April 2015) “Impact of polymer electrolyte membrane fuel cell microporous layer nan-scale features on thermal conductance,” J. Power Sources 280:173-181.
37. Wang X. L. et al. (2006) “Micro-porous layer with composite carbon black for PEM tuel cells,” Electrochimica Acta 51(23):4909-4915.
38. Karimi S. et al. (2012) “A Review of Metallic Bipolar Plates for Proton Exchange Membrane Fuel Cells: Materials and Fabrication Methods,” Adv. Materials Science and Engineering 2012:Article ID 828070 (22 pages).

1) A membrane electrode assembly which comprises:
a polymer electrolyte membrane; and
at least one self-supporting catalyst layer comprising a porous film having an open network of interconnected pores.

2) The membrane electrode assembly of claim 1, wherein:
(a) the porous film is made of carbon, nickel, titanium, gold, platinum, tantalum, metal oxides or carbon-coated metal or metal oxides;
(b) the porous film is carbon-based;
(c) the porous film is electrically conductive;
(d) the network comprises pores having a diameter from 2 nm to 100 nm;
(e) the network comprises pores having a diameter larger than 100 nm; or
(f) the network comprises pores having a diameter from 2 nm to 100 nm and further comprises pores having a diameter greater than zero and less than 2 nm or from 0.1 μm to 100 μm.

3) The membrane electrode assembly of claim 1, wherein a gradient in porosity is present across the thickness of the film, and/or in the planar directions of the film.

4) The membrane electrode assembly of claim 1, wherein the film is carbon-based and the surface of the carbon-based film is modified by at least one functional group selected from fluorine-containing groups, nitrogen-containing groups, sulfur-containing groups, oxygen-containing groups, phosphorous-containing groups, boron-containing groups, silicon-containing groups, arsenic-containing groups, selenium-containing groups, chlorine-containing groups, bromine-containing groups, and iodine-containing groups.

5) The membrane electrode assembly of claim 1, wherein the porous film is proton conductive.

6) (canceled)

7) (canceled)

8) (canceled)

9) (canceled)

10) The membrane electrode assembly of claim 1, wherein the porous film further comprises metallic catalyst nanoparticles, or metal oxide catalyst nanoparticles,
wherein the metallic nanoparticles are selected from the group consisting of Pt, Pd, Ir, Ni, Au, Co, Ru, Rh, Fe, Ag, Cu, Ti, Ta and combinations thereof; and
the metal oxide nanoparticles are selected from the group consisting of ruthenium oxide, iridium oxide, titanium oxide, tantalum oxide, cobalt oxide, iron oxide, nickel oxide, tungsten oxide, manganese oxide, chromium oxide, vanadium oxide, yttrium oxide, osmium oxide, silver oxide, molybdenum oxide and combinations thereof.

11) (canceled)

12) (canceled)

13) The membrane electrode assembly of claim 1, wherein the porous film further comprises a conformal thin film of a catalyst selected from the group consisting of Pt, Pd, Ir, Ni, Au, Co, Ru, Rh, Fe, Ag, Cu, Ti, Ta and combinations thereof.

14) (canceled)

15) (canceled)

16) (canceled)

17) The membrane electrode assembly of claim 1, wherein the catalyst layer further comprises at least one of a polymer electrolyte or an ionomer.

18) The membrane electrode assembly of claim 17, wherein there is a gradient in the concentration of the polymer electrolyte or the ionomer within the catalyst layer.

19) The membrane electrode assembly of claim 1 which comprises a first self-supporting catalyst layer on one side of the polymer electrolyte membrane and a second catalyst layer on the other side of the polymer electrolyte membrane, said second catalyst layer being a self-supporting catalyst layer or a catalyst layer other than a self-supporting catalyst layer.

20) (canceled)

21) (canceled)

22) (canceled)

23) (canceled)

24) (canceled)

25) The membrane electrode assembly of claim 1, wherein the first self-supporting catalyst layer is positioned between the polymer electrolyte membrane and a first gas diffusion layer.

26) The membrane electrode assembly of claim 25, wherein a microporous layer is positioned between the first self-supporting catalyst layer and the first gas diffusion layer.

27) (canceled)

28) (canceled)

29) (canceled)

30) The membrane electrode assembly of claim 26, wherein the microporous layer is self-supporting.

31) The membrane electrode assembly of claim 1 which comprises:
a polymer electrolyte membrane;
a catalyst layer on each side of the membrane; and
at least one self-supporting microporous layer comprising a porous film having an open network of interconnected pores.

32) (canceled)

33) The membrane electrode assembly of claim 31, wherein a gradient in porosity is present across the porous film.

34) The membrane electrode assembly of claim 31, wherein the film is carbon-based and surface of the carbon-based film is modified by functional groups selected from the group consisting of pentafluorophenyl, aminophenyl, nitrophenyl, phenyl sulfonic acid and combinations thereof.

35) (canceled)

36) (canceled)

37) The membrane electrode assembly of claim 31, wherein a gas diffusion layer is attached to one side of the assembly or there is no gas diffusion layer attached to the self-supporting microporous layer of the assembly.

38) The membrane electrode assembly of claim 31, wherein one or both of the catalyst layers are self-supporting.

39) A fuel cell comprising the membrane electrode assembly of claim 1.

40) A method for generating electricity which comprises operating a fuel cell of claim 39.
